(19) United States
(12) Patent Application Publication
(10) Pub. No.: US 2012/0284231 A1
(43) Pub. Date: Nov. 8, 2012

(54) DISTRIBUTED, ASYNCHRONOUS AND FAULT-TOLERANT STORAGE SYSTEM

(75) Inventors: Cristina Basescu, Zurich (CH); Christian Cachin, Zurich (CH); Ittay Eyal, Zurich (CH); Robert Haas, Zurich (CH); Marko Vukolic, Golfe Juan (FR)

(73) Assignee: International Business Machines Corporation, Armonk, NY (US)

(21) Appl. No.: 13/463,933

(22) Filed: May 4, 2012

(30) Foreign Application Priority Data
May 6, 2011 (EP) 11165040.4

(51) Int. Cl. G06F 17/30

(52) U.S. Cl. 707/638; 707/E17.032; 707/E17.005

(57) ABSTRACT

Methods and systems for reading from and writing to a distributed, asynchronous and fault-tolerant storage system. The storage system includes storage nodes communicating with clients. The method includes a first client writing an object to the storage system and a second client reading the object from the storage system. For the first client, previous transient metadata relating to a previously written version of the object is retrieved and a new version of the object together with new transient metadata is stored. For the second client, a set of transient metadata from a third set of nodes amongst storage nodes is retrieved, a specific version of the object as stored on the storage system is determined, and a specific version of the corresponding object from a fourth set of nodes amongst storage nodes is retrieved. Two sets of nodes amongst all sets have at least one node in common.

### CROSS REFERENCE TO RELATED APPLICATION

This application claims priority under 35 U.S.C. 119 from European Application 11165040.4, filed May 6, 2011, the entire contents of which are incorporated herein by reference.

### BACKGROUND OF THE INVENTION

1. Field of the Invention

The present invention broadly relates to computerized methods and systems for reading from and writing to a distributed, asynchronous and fault-tolerant storage system, the latter including storage nodes and communicating with clients. A storage node of the storage system is for example a remote web service accessed over the Internet.

2. Description of the Related Art

Recent years have seen an explosion of Internet-scale applications, ranging from those in web search to social networks. These applications are typically implemented with many machines running in multiple data centers. In order to coordinate their operations, these machines access some shared storage. In this context, a prominent storage model is the key-value store (KVS). A KVS offers functions for storing and retrieving objects (called values) associated with unique keys. KVSs have become widely used as shared storage solutions for Internet- scale distributed applications. A KVS offers a range of simple functions for the manipulation of unstructured data objects (called values), each one identified by a unique key. KVSs are used as storage services directly (such as in Amazon® Simple Storage Service and Windows Azure® Storage) or indirectly, as non-relational (NoSQL) databases (as shown in A. Lakshman and P. Malik. Cassandra: A decentralized structured storage system. SIGOPS Oper. Syst. Rev., 2010, 35-40, 44., and Project Voldemort: A distributed database. http://project-voldemort.com/). While different services and systems offer various extensions to the KVS interface, the common denominator of existing KVS services implements an associative array: a client may store a value by associating the value with a key, retrieve a value associated with a key, list the keys that are currently associated, and remove a value associated with a key.

Storage services provide reliability using replication and tolerate the failure of individual data replicas. However, when all data replicas are managed by the same entity, there are naturally common system components, and therefore failure modes common to all replicas. A failure of these components may lead to data becoming not available or even being lost, as recently witnessed during an Amazon S3 outage and Google's temporary loss of email data.

Therefore, a client can increase data reliability by replicating it among several storage services using the guarantees offered by robust distributed storage algorithms (for example, in D. K. Gifford. Weighted voting for replicated data. In Symposium on Operating System Principles (SOSP), 1979, 150-162., and H. Attiya, A. Bar-Noy, and D. Dolev. Sharing memory robustly in message-passing systems, J. ACM, 1995, 124-142, 42(1)).

### BRIEF SUMMARY OF THE INVENTION

In order to overcome these deficiencies, the present invention provides a method for reading from and writing to a distributed, asynchronous and fault-tolerant storage system including storage nodes, the storage nodes communicating with clients, the method including: from a first client writing an object to the storage system: retrieving from a first set of nodes amongst the storage nodes previous transient metadata relating to a previously written version of the object; and storing a new version of the object together with new transient metadata identifying the new version on a second set of nodes amongst the storage nodes, wherein the new transient metadata are metadata computed based on the previous transient metadata; and from a second client reading the object from the storage system: retrieving a set of transient metadata from a third set of nodes amongst the storage nodes; determining from the set of transient metadata retrieved a specific version of the object as stored on the storage system; and retrieving the specific version of the corresponding object from a fourth set of nodes amongst the storage nodes, wherein two sets of nodes amongst the first, second, third and fourth sets have at least one node in common.

According to another aspect, the present invention provides a computer program product for causing one or more clients communicating with a distributed, asynchronous and fault-tolerant storage system including storage nodes, the computer program product including: a computer readable storage medium having computer readable non-transient program code embodied therein, the computer readable program code including: computer readable program code configured to perform the steps of a method, including: from a first client writing an object to the storage system: retrieving from a first set of nodes amongst the storage nodes previous transient metadata relating to a previously written version of the object; and storing a new version of the object together with new transient metadata identifying the new version on a second set of nodes amongst the storage nodes, wherein the new transient metadata are metadata computed based on the previous transient metadata; and from a second client reading the object from the storage system: retrieving a set of transient metadata from a third set of nodes amongst the storage nodes; determining from the set of transient metadata retrieved a specific version of the object as stored on the storage system; and retrieving the specific version of the corresponding object from a fourth set of nodes amongst the storage nodes, wherein two sets of nodes amongst the first, second, third and fourth sets have at least one node in common.

According to yet another aspect, the present invention provides a distributed, asynchronous and fault-tolerant storage system including: storage nodes, wherein the storage nodes communicate with clients; a first client that writes an object to a storage system, wherein the first client retrieves from a first set of nodes amongst storage nodes previous transient metadata relating to a previously written version of the object and stores a new version of the object together with new transient metadata identifying the new version on a second set of nodes amongst the storage nodes, wherein the new transient metadata are metadata computed based on the previous transient metadata; and a second client that reads the object from the storage system, wherein the second client retrieves a set of transient metadata from a third set of nodes amongst the storage nodes, determines from the set of transient metadata retrieved a specific version of the object as stored on the storage system, and retrieves the specific version of the corresponding object from a fourth set of nodes amongst the storage nodes, wherein two sets of nodes amongst the first, second, third and fourth sets have at least one node in common.

### BRIEF DESCRIPTION OF THE SEVERAL VIEWS OF THE DRAWINGS

FIG. 1 schematically depicts a distributed, asynchronous and fault-tolerant storage system including storage nodes communicating with clients, according to embodiments;

FIG. 2 schematically illustrates a storage node equipped with key-value storage interfaces, wherein keys (metadata) identify versions of stored objects (values);

FIG. 3 is a flowchart showing high-level steps of a method for reading from and writing to a storage system, according to embodiments;

FIG. 4 shows another flowchart of typical, high-level steps as implemented in alternate embodiments; and

FIG. 5 illustrates components/functions of a computerized unit (e.g., a storage entity of a storage node or a client) suitable for implementing embodiments of the invention.

### DETAILED DESCRIPTION OF THE INVENTION

First, general aspects of methods according to embodiments of the invention are discussed, together with high-level variants thereof (section 1). Next, in section 2, more specific embodiments are described.

### 1. General Aspects of the Invention

### 1.1 Main Aspects

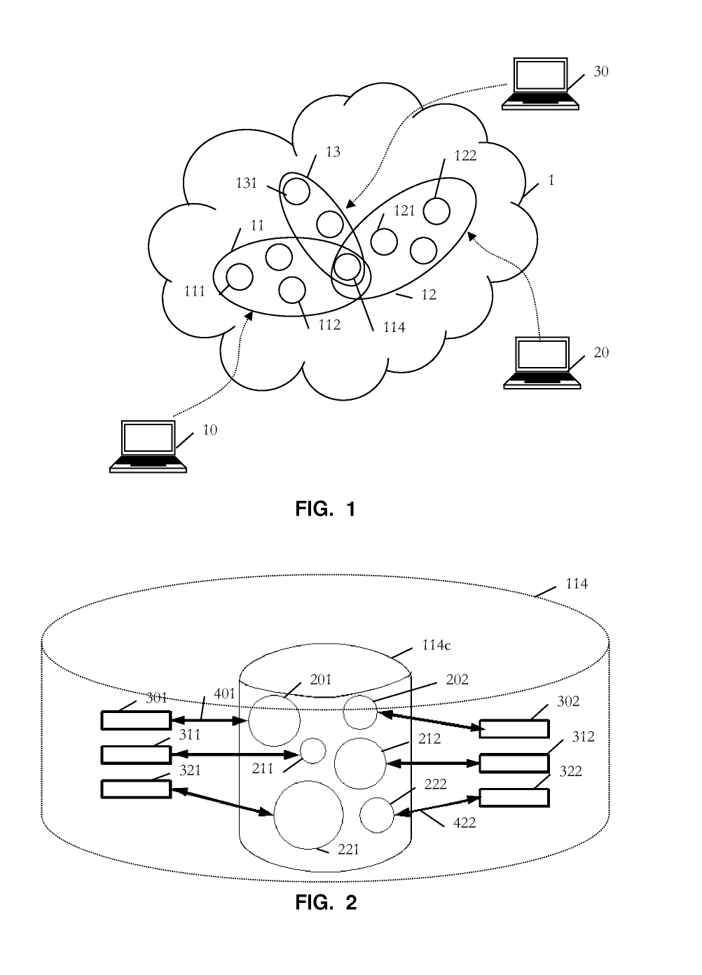

In reference to FIGS. 1-4, present methods involve a distributed, asynchronous and fault-tolerant storage system 1. As illustrated in figure one, this can include storage nodes 111-131, communicating with clients 10, 20, and 30 reading from and/or writing to the storage system 1. Typically, a node here is a remote web service accessed over the Internet, e.g., a “cloud”. A “distributed, asynchronous” system essentially means that (i) many nodes are involved and (ii) some of the nodes are allowed to respond to client requests, i.e., read/write requests, with unspecified delays, as known in the art. Also, “fault-tolerant” storage system means that at least some of the nodes are allowed not to respond.

Furthermore, as depicted in FIG. 1, the distributed system 1 includes nodes, which can be grouped into sets 11-13 of nodes, represented by ellipses, inside the whole storage system 1. The structure of the ellipses (i.e., two sets of nodes amongst sets 11, 12, and 13 have at least one node 114 in common) compares to a so-called quorum system. Such systems are known per se: a quorum system includes several quorums such that each pair of quorums has one node in common. This ensures that if a client 10 interacts with one quorum 11, then effects of such an interaction are visible by another client 20 or 30 interacting with another quorum of the quorum system. More generally, in the present context, it is assumed that each pair of sets of nodes has at least one node 114 in common, whereby the effects of interactions with one set can be replicated at another set. For simplicity, in FIG. 1, all the sets are represented as having a same common node 114. Similarly, while the following description alludes to several sets of nodes, only three sets 11, 12, and 13 are represented in FIG. 1, for clarity.

In essence, what the present methods provide is to allow clients communicating with the storage system to implement the following steps.

First, let us consider a first client 10, which is in a process of writing an object 201-202, as shown in FIG. 2, to the storage system 1. In passing, an “object” is typically a picture, video or audio file. More generally, it can be any type of digital file, e.g., geometrical specifications of a modeled object or, simply, a word processing document. The present context assumes that several versions of such an object can be stored on the storage system. Equivalently, the versions of an object could be instances of a same object. Thus, an “object” generally refers to the set of digital file versions written or to be written for that object.

The client 10 shall typically perform the following two steps:

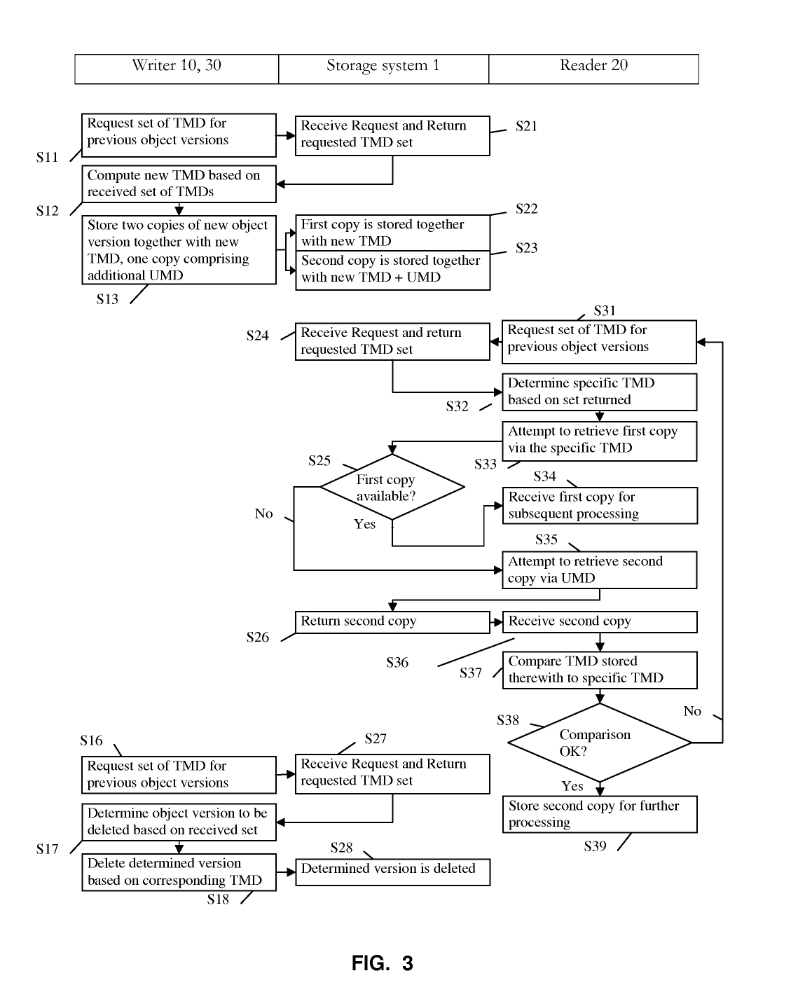

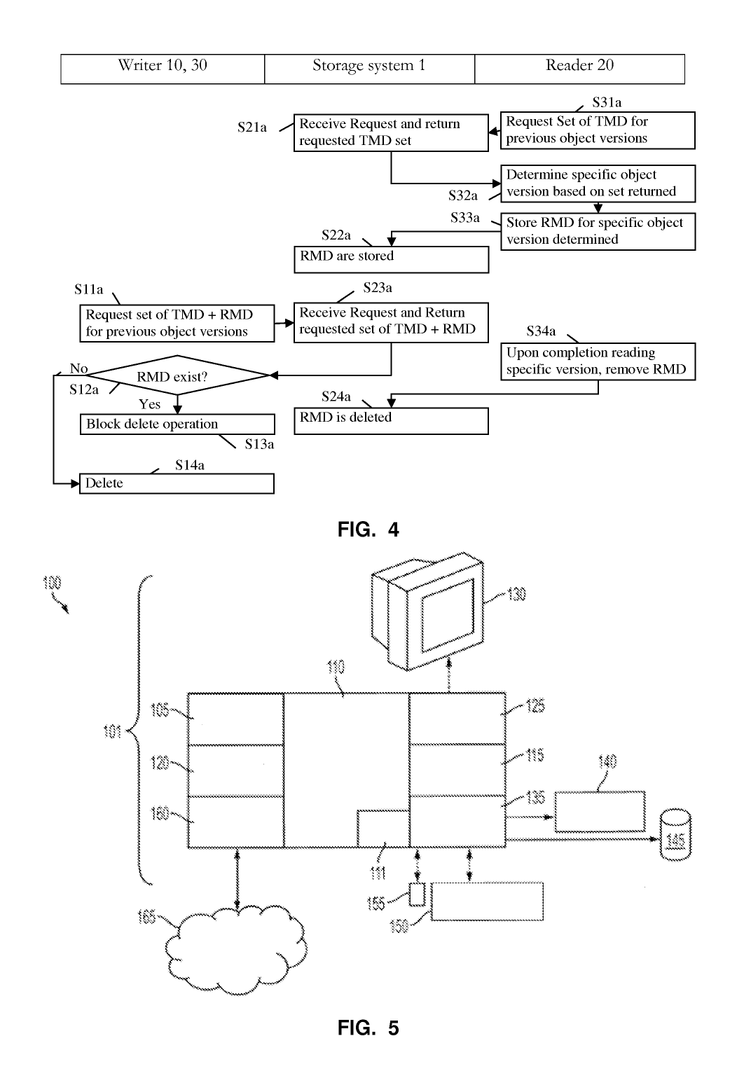

In step S11, FIG. 3, the client retrieves from a first set 11 of nodes previous transient metadata (e.g., 301 in FIG. 2, denoted by TMD in FIGS. 3-4, for short) relating to a previously written version of the object. Typically, TMD are timestamps or keys, as in the concept of key-value storage to be discussed later. The step of “retrieving” previous TMD may for instance decompose into a request issued from client 10, step S11, FIG. 3, to the storage system 1, such as a “List” command. The system then obeys the command and the set of previous TMD are returned to the requester in step S21.

Next, in step S13, FIG. 3, the first client stores a new version 202 of the object, e.g., by way of a “Put”, together with new TMD 302, the latter identifying the new version. The new version is stored on a second set of nodes (i.e., possibly distinct from the first set) in steps S22-S23.

The new TMD are computed based on previous TMD. For instance, a simple way is to increment a version number. Interestingly, the above TMD update mechanism provides a possible definition for the corresponding object (i.e., the set of a version previously written or still to be written). In other words, an object is preferably defined by a corresponding TMD sequence, rather than by the semantic contents of the object versions, which can vary tremendously from one version to another. The new TMD can be computed anywhere. It may for instance be computed at the client 10 itself, as illustrated in step S12, FIG. 3. In variants, the TMD are predetermined, made available to the client 10, with the client simply inquiring about the new TMD when needed. In that case, the first client would simply allocate the new TMD at step S12, without computing them. Also, because the object versions corresponding to computed TMD are likely deleted or replaced after some time, the object versions are “transient”, and so are the corresponding TMD. Thus, transient metadata typically means administrative metadata, relating to the storage of transient object versions. They are furthermore called transient metadata as opposed to the concept of universal metadata that shall be introduced later.

Now, let us consider a second client 20 attempting to read the same object (or in fact, any other object) from the storage system. This second client, who possibly is the same as the first client, shall typically perform the following steps:

In step S31 (FIG. 3, or S31a in FIG. 4): it retrieves a set of TMD 301-302 from a third set 12 of nodes (possibly distinct from the previous sets of nodes). Again, a “List” command is typically relied upon, whereby the system 1 reacts by returning the requested set, step S24 (FIG. 3, or S21a FIG. 4). In fact, the second client does not know exactly what version it wants so far. Rather, it just knows that the corresponding metadata should match a given criterion, e.g., the latest version.

In step S32 (FIG. 3, or S32a, FIG. 4), the second client determines from the retrieved TMD set a specific version (e.g., object version 202) of the object as stored on the storage system 1. To achieve this, it identifies the corresponding TMD (e.g., specific TMD 302) based on a given criterion. The specific TMD are for example the TMD corresponding to the most recently written version, e.g., having the highest number.

Note that the TMD set retrieved may actually correspond to all versions of all objects as stored on the system 1. In that case, upon client request, a node blindly returns all TMD corresponding to all objects stored thereon. In an embodiment, the TMD set returned can restrict to a given class (or even to a single object) and the request can be made correspondingly, such as to minimize the volume of TMD traffic and subsequent work at the requesting client for determining the desired version.

Next, in steps S33-S39, the second client 20 retrieves the specific version of the corresponding object from a fourth set (here also represented as set 12) of nodes. Again, a “Get” command can be used and the fourth set does not need to exactly correspond to the previous set of nodes. Rather, two sets of nodes (any pair of sets) amongst the first, second, third and fourth sets shall have at least one node 114 in common, as illustrated in FIG. 1 (i.e., quorum system property).

Also illustrated in FIG. 2 but not described in detail above are TMD 311-322 with corresponding objects 211-222.

A method such as described above enables computation-free storage nodes, at variance with prior art methods. For example, in typical prior art methods, a client makes a read request and what is returned by a node to the client is a pair {metadata, object}. Thus, if the client makes a first read request at time t1 and a second read request at time t2, then two versions of the object are returned, one after each read request. In the present case, the substantial data (i.e., corresponding to the desired version) are returned only once the client has determined which version it wants.

Additional advantages reside in the fact that the “intelligence” can be delocalized to the clients. For example, the clients can implement garbage collection schemes, instead of having them implemented at the nodes (garbage collection schemes aim at removing obsolete object versions, as known per se).

In contrast, in prior art methods, the nodes were able to and thus required to determine what the desired (specific) version was. For example, the nodes were equipped with the necessary intelligence to keep only the most recent version of the stored objects. Now, this is done by the client. The client determines which version is the one it wants.

In sections 1.3 and 2 below, two classes of embodiments are contemplated, examples of which are respectively captured in FIGS. 3 and 4. These two classes of embodiments will be discussed broadly in section 1.3. Very specific embodiments, relating to FIG. 3, shall be discussed in section 2. What is discussed in the next section (1.2) concerns both classes of embodiments.

### 1.2 High-Level Options

To start with, embodiments of the present invention may specifically address issues related to garbage collection (and more generally, the alteration of the stored object versions).

For example, a third client 30 (e.g., possibly any client which is ‘aware’ of outdated versions, shall take steps to retrieve (S16, FIG. 3) a set of TMD from, say, a fifth set 13 of nodes. A “List” command is typically issued, whereby the system 1 returns the desired set of TMD, step S27. The third client 30 can accordingly determine (step S17) one or more versions of objects to be altered, by identifying the corresponding TMD. To do that, a second criterion can be relied upon (i.e., find all versions which are not the latest one, such as the outdated versions). Thus, the client 30 can subsequently instruct the storage system to alter (e.g., delete) the object versions which were determined to correspond to versions be altered, steps S18 and S28. This, way, client 30 (or any other client, e.g., a client permitted to do so) can implement a garbage collection process. In variants, client 30 may instruct that outdated versions are compressed. Again, two sets of nodes (including now the fifth set) have at least one node in common.

As will be discussed now, the above methods can be optimally implemented when storage nodes are equipped with key-value storage interfaces or any suitable interfaces which support the client-driven operations. Such an interface can be defined as a convention by which a client interacts with a storage node. In that case, a node (such as node 114 depicted in FIG. 2) can be called a key-value storage node (also key-value store or KVS for short). There, the TMD (e.g., 301 in FIG. 2) corresponding to a given version 201 of a stored object (the “value”) include a key 301 uniquely identifying the version 201. Objects 201-222 are stored on some convenient storage medium 114c of the node 114.

This is illustrated in FIG. 2. The storage node 114 is equipped with a respective KVS interface, symbolized by the set of arrows 401-422. To talk to a node, clients are for example equipped with tools to access a node's KVS interface. A suitable interface includes operations notably allowing a client communicating with a storage node for the following two steps:

Storing thereon a pair including a key (e.g., 301) and a corresponding object 201 (see also step S13 in FIG. 3). “Storing” typically involves a “Put” operation.

Next, retrieving from the node (e.g., “Get” command) an object (e.g., object 201) for a given key (e.g., key 301) (see also FIG. 3, step S33 or S35).

In addition, providing nodes with KVS interfaces allows, at the step of retrieving specific TMD 302 (step S31, FIG. 3 or S31a, FIG. 4), for a client 20 to instruct one or more nodes 114 (in fact all of the nodes are typically instructed to do so) to list (e.g., “List” command) keys 301 and 302 corresponding to pairs of a key and object as stored on the one or more nodes.

Preferably, the interfaces are further provided with an operation allowing a client for deleting (e.g., “Remove” command) a pair (a key and an object), by providing a key to the interface, such as to implement a delocalized garbage process.

### 1.3 Two Classes of Embodiments: Universal vs. Reservation Metadata

Embodiments of FIG. 3 and FIG. 4 differ essentially in that in the first case, additional metadata are placed by the writer (hereafter called universal metadata), whereas in the second case, reservation metadata are placed by the reader when accessing a file. Sections 1.3.1 and 1.3.2 below broadly address each class of embodiments and variants thereto.

### 1.3.1 Universal Metadata

Here, when the first client stores a new object version (step S13, FIG. 3), it actually stores two copies (or more) of the new object version, steps S13 and S22-S23. The first copy is stored together with the new TMD, as computed from the previous TMD already obtained for that same object. The second copy is stored together with universal metadata (or UMD, step S23, FIG. 3). Such metadata are said to be “universal” inasmuch as they are known (or can be known) by several clients.

In practice, the UMD shall allow a client to access the second copy when the first is not available, e.g., the corresponding object has been removed by a quicker garbage collector or superseded by a writer, it being reminded that the present system is asynchronous.

For example, when retrieving a specific version of an object, the reader 20 attempts (step S33, FIG. 3) to retrieve a first copy of the specific version, based on specific TMD, the latter determined as explained earlier (steps S31-S32, FIG. 3). Now, if the first copy cannot be obtained for some reason, client 20 shall attempt (step S35) to retrieve the second copy, relying this time on UMD associated with the specific version desired.

Preferably, the second copy is stored together with both the UMD and the new TMD. Thus, when accessing the second copy, the reader 20 can compare (step S37) the associated TMD (i.e., stored together with the second copy) with the specific TMD retrieved earlier, such as to verify that the retrieved copy is consistent with the initial request.

The likely scenario is that the first copy is normally available, step S25, in which case the reader 20 can access it for any subsequent use (read, parse in RAM or replication, etc.), step S34. However, if the first copy is not available, then there is still the possibility for the reader to access the second copy.

Now, if the reader needs to ascertain that the second copy is the version actually desired, an additional comparison step, step S38, is needed in step S37. Typically, the additional comparison is carried out in order to determine whether the second copy corresponds to the most recent version. Technically, the reader checks whether the second copy has been written “no earlier than” the first copy, i.e., the copy corresponding to the retrieved specific TMD. To do that, the reader may for instance compare the TMD stored together with the second copy with the retrieved specific TMD. Nonetheless, other criteria might be involved, involving version compatibility, for collaborative work, etc.

In all cases, if an outcome of the comparison step does not conform to expectations, then the reader 20 may proceed to repeat the previous steps S31-S34, and if necessary step S35, etc., until the comparison leads to a satisfactory outcome, steps S38-S39. This way, a complete solution is offered which allows for reading from and writing to a distributed, asynchronous and fault-tolerant storage system.

### 1.3.2 Reservation Metadata

Here the paradigm is different. In the embodiment described below, the reader 20 “reserves” a version when reading it. An exemplary scenario is the one illustrated in FIG. 4 (not all steps as described in sections 1.1 or 1.2 are illustrated, for conciseness).

As described before, when the second client 20 wishes to access an object from system 1, it shall first retrieve in step S31 a of FIG. 4 a set of TMD (e.g., 301 or 302 in FIG. 2) from the third set of nodes. Next, it determines in step S32a from the retrieved set of TMD a specific version (e.g. 202) of an object stored on the system 1. In an embodiment, this is done as explained earlier in steps S31-S32 in FIG. 3.

Next, the second client 20 proceeds to store (steps S33a and S22a) reservation metadata (or RMD) for the specific version 202 it wants to access, on the storage system 1. Again, the RMD can be stored on any set of nodes having at least one node in common with any other set of nodes mentioned above.

Then, the specific version can be retrieved from any set of nodes, for subsequent use by the reader, as explained before. Upon completion, the reader can instruct in step S34a that the corresponding RMD is removed, for example, from one or more nodes of the system 1, and in practice as many as possible. In step S24a, the corresponding RMD is deleted.

Now, consider a client 10 or 30, which wants to write or access the same object, which is assumed to be concurrently accessed by the second client 20. This client 10 or 30 starts with retrieving (step S11a) previous TMD, i.e., relating to previously written versions 201 of this object, just as described earlier. In addition, this client shall inquire about reservation metadata, if any, which are associated with any version 202 of that object. If, as assumed in FIG. 4, a version of that object is concurrently accessed by another client (reader 20 in this occurrence), then the client 10 or 30 shall be informed via the corresponding retrieved RMD in steps 11a, 23a, and 12a.

The client 10 or 30 then knows that the reserved version needs special treatment. For example, in step 13a it will refrain from deleting the reserved version. Elsewise, in absence of a reservation, the reserved version can be safely deleted in step S14a.

This scheme is particularly useful for avoiding collisions, inasmuch as reservation metadata are placed by the reader before accessing the corresponding version. Again, the garbage collection processes or, more generally, the decisions taken as to the stored files are delegated to the clients rather than the nodes. Such a scheme offers improved security for clients who do not want to jeopardize the security of files managed directly by the storage system.

Notwithstanding, an issue with this second embodiment class is that the reader may not have the permission to “write”, and thus might not be able to “reserve” the files being accessed, i.e., to store reservation metadata. In that extent, the first embodiment class described in section 1.3.1 is preferred.

Finally, here again, the reservation metadata are preferably computed based on reservation metadata and/or transient metadata as previously stored for the object being concurrently accessed, whereby an easy scheme is provided to manage the version numbers.

### 2. Additional Consideration for Specific Embodiments

The following provides details as to specific, fault-tolerant, wait-free and efficient algorithms that emulate a multi-reader multi-writer register from a set of KVS replicas in an asynchronous environment. Implementations serve an unbounded number of clients that use the storage. It tolerates crashes of a minority of the KVSs and crashes of any number of clients. These algorithms can be regarded as detailed variants to the methods discussed in section 1.3.1 above. Nonetheless, skilled person may appreciate that details given hereafter can be applied as variants to the methods discussed in section 1.3.2.

As known in the art, a client can increase data reliability by replicating it among several storage services using the guarantees offered by robust distributed storage algorithms. Such an algorithm uses multiple storage providers (e.g., storage nodes as introduced earlier), and emulates a single, more reliable shared storage abstraction, which can be modeled as a read/write register. Such a register can be designed to tolerate asynchrony, concurrency, and faults among the clients and the storage nodes.

Many well-known robust distributed storage algorithms exist. Perhaps surprisingly, none of them directly exploits key-value stores as storage nodes. The problem arises because existing solutions are either (1) unsuitable for KVSs since they rely on storage nodes that perform custom computation, which a KVS cannot do, or (2) prohibitively expensive, in the sense that they require as many storage nodes as there are clients.

First, the challenges behind running robust storage algorithms over a set of KVS nodes are described.

### 2.1 Challenges

Many existing robust register emulations are based on versioning, in the sense that they associate each stored value with a version (sometimes called a timestamp) that increases over time. Consider the classical multi-writer emulation of a fault-tolerant register. A writer determines first the largest version from some majority of the storage nodes, derives a larger version, and then stores the new value together with the larger version at a majority of storage nodes. The storage node then performs computation and actually stores the new value only if it comes with a larger version than the one it stores locally. However, a KVS does not offer such an operation.

Similar to existing emulations, a robust storage solution is desired which is wait-free, such that every correct client may proceed independently of the speed or failure of other clients (or more precisely, every operation invoked by a correct client eventually completes).

If a classical algorithm is cast blindly into the KVS context without adjustment, all values are stored with the same key. This may cause a larger version and an associated, recently written value to be overwritten by a smaller version and an outdated value. This shall be referred to as “the old-new overwrite problem”. Another equally naive solution is to store each version under a separate key; such a KVS accumulates all versions that have ever been stored and takes up unbounded space. As remedy for this, one could remove small versions from a KVS after a value with a larger version has been stored. But this might, in turn, jeopardize wait-freedom. Consider a read operation that lists the existing keys and then retrieves the value with the largest version. If this version is removed between the time when the KVS executes the list operation and the time when the client retrieves it from the KVS, the read operation will fail. This can be referred to as “the garbage-collection race problem”.

### 2.2 Details of Preferred Algorithms

First, a formal definition of a KVS is provided. A key-value store as used in embodiments is an associative array that allows storage and retrieval of values in a set V associated with of keys in a set K. The space complexity of the values is much larger than that of keys, so the values in V cannot be translated to elements of K and be stored as keys.

A KVS typically supports the following operations: (1) Associating a value with a key (Put(Key, Value)), (2) retrieving a value associated with a key (Get(Key)), (3) listing the keys that are currently associated (List( ) and (4) removing a value associated with a key (Remove(Key)). A possible formal sequential specification of the KVS is given in algorithm 1 shown in illustration 1 below:

Algorithm 1: Key-Value Storage Object i
1 state

| | |
|---|---|
| 2 | liveRegs ⊂ K × V, initially |

3 On invocation putᵢ(key, value)

| | |
|---|---|
| 4 | liveRegs ← (liveRegs \ { [symbol] key, x [symbol] \|x ∈ V}) ∪ (key. value) |
| 5 | return ACK |

6 On invocation getᵢ(key)

| | |
|---|---|
| 7 | if ∃x : [symbol] key, x [symbol] ∈ liveRegs then |

| | |
|---|---|
| 8 | return x |

| | |
|---|---|
| 9 | else |

| | |
|---|---|
| 10 | return FAIL |

11 On invocation removeᵢ (key)

| | |
|---|---|
| 12 | liveRegs ← liveRegs \ { [symbol] key, x [symbol] \|x ∈ V} |
| 13 | return ACK |

14 On invocation listᵢ( )

| | |
|---|---|
| 15 | return {key\|∃x : [symbol] key, x [symbol] ∈ liveRegs} |

Having noted this, two types of robust, asynchronous, and efficient emulations of a register over a set of fault-prone KVS replicas are particularly preferred, as described above. The reader may appreciate that both emulations can be designed for an unbounded number of clients, which may all read from and write to the register (i.e., the emulations implement a multi-writer multi-reader register). This makes it appropriate for Internet-scale systems. Also, both emulations may provide a multi-writer regular register. They may further be implemented so as to be wait-free and optimally resilient, i.e., the algorithm tolerates crash-stop failures of any minority of the KVS replicas and of any number of clients.

However, both emulations differ in their requirements. The first one (using universal metadata) does not require read operations to write to KVSs (that is, to change the state of a KVS by storing a value), in contrast with the second one. Precluding readers from storing values is practically appealing, since the clients may belong to different domains and not all of them should be permitted to write to the shared memory. But this poses a problem because of the garbage-collection race problem described previously. Thus, methods according to this first emulation instruct a write operation to store the same value twice, under different keys: once under an eternal key (universal metadata), which is never removed by garbage collection but vulnerable to an old-new overwrite, and a second time under a temporary key, named according to the version, as discussed earlier in reference to FIG. 3. Outdated temporary keys are garbage-collected periodically, for instance by write operations, which exposes them to garbage-collection races. Taken together, however, the eternal and temporary copies complement each other and guarantee a wait-free emulation with regular semantics.

### 3. Final Considerations for Computerized Units Involved

Entities (computers) in the nodes of the system 1 are configured to store and replicate data, and return data as requested by clients, which are computerized units as well. The nodes themselves (e.g., clouds) preferably implement interfaces such as is described above (e.g., KVS interfaces). In all cases, the entities and clients can be regarded as a computerized unit or a set of computerized units such as is depicted in FIG. 5.

Such computerized units are designed for implementing aspects of the present invention as described above. In that respect, it will be appreciated that the methods described herein are largely non-interactive and automated. In embodiments, the methods described herein can be implemented either in an interactive, partly-interactive or non-interactive system. The methods described herein can be implemented in software (e.g., firmware), hardware, or a combination thereof. In embodiments, the methods described herein are implemented in software, as an executable program, the latter executed by special digital computers (at the clients and/or at the node entities). More generally, embodiments of the present invention can be implemented using general-purpose digital computers, such as personal computers, workstations, etc.

The system 100 depicted in FIG. 5 schematically represents a computerized unit 101, e.g., a general-purpose computer that can play the role of a node entity or a client. In embodiments, in terms of hardware architecture, as shown in FIG. 5, the unit 101 includes a processor 105, memory 110 coupled to a memory controller 115, and one or more input and/or output (I/O) devices 140, 145, 150, 155 (or peripherals) that are communicatively coupled via a local input/output controller 135. The input/output controller 135 can be, but is not limited to, one or more buses or other wired or wireless connections, as is known in the art. The input/output controller 135 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 105 is a hardware device for executing software, particularly software stored in memory 110. The processor 105 can be any custom made or commercially available processor, a central processing unit (CPU), an auxiliary processor among several processors associated with the computer 101, a semiconductor based microprocessor (in the form of a microchip or chip set), or generally any device for executing software instructions.

The memory 110 can include any one or combination of volatile memory elements (e.g., random access memory) and nonvolatile memory elements. Moreover, the memory 110 may incorporate electronic, magnetic, optical, and/or other types of storage media. Obviously, the memory 110 can have a distributed architecture, where various components are situated remote from one another, but can be accessed by the processor 105.

The software in memory 110 may include one or more separate programs, each of which includes an ordered listing of executable instructions for implementing logical functions. In the example of FIG. 5, the software in the memory 110 includes methods (or parts thereof, i.e., some of the steps) described herein in accordance with exemplary embodiments and a suitable operating system (OS) 111. The OS 111 essentially controls the execution of other computer programs, such as the methods as described herein (e.g., FIGS. 3-4), and provides scheduling, input-output control, file and data management, memory management, and communication control and related services.

The methods described herein can be in the form of a source program, executable program (object code), script, or any other entity including a set of instructions to be performed. When in a source program form, the program needs to be translated via a compiler, assembler, interpreter, or the like, which may or may not be included within the memory 110, so as to operate properly in connection with the OS 111. Furthermore, the methods can be written as an object oriented programming language, which has classes of data and methods, or a procedure programming language, which has routines, subroutines, and/or functions.

Possibly, a conventional keyboard 150 and mouse 155 can be coupled to the input/output controller 135. In addition, the I/O devices 140-155 may further include devices that communicate both inputs and outputs. The system 100 can further include a display controller 125 coupled to a display 130. The system 100 typically includes a network interface or transceiver 160 for coupling to a network 165, and thereby to the storage system 1 (FIG. 1).

The network 165 transmits and receives data between the unit 101 and other entities (nodes/clients). The network 165 can be a packet-switched network such as the Internet network. Embodiments can also be contemplated which apply to local area networks, wide area networks, or other types of network environments. There are many possible types of technologies (e.g., fixed wireless network, wireless local area network, wireless wide area network), which can be involved here, are known per se, and do not need to be further described here.

If the unit 101 is a PC, workstation, intelligent device or the like, the software in the memory 110 may further include a basic input output system (BIOS) (omitted for simplicity). The BIOS is stored in ROM so that the BIOS can be executed when the computer 101 is activated.

When the unit 101 is in operation, the processor 105 is configured to execute software stored within the memory 110, to communicate data to and from the memory 110, and to generally control operations of the computer 101 pursuant to the software. The methods described herein and the OS 111, in whole or in part are read by the processor 105, typically buffered within the processor 105, and then executed.

When the systems and methods described herein are implemented in software, the methods can be stored on any computer readable medium, such as storage 120, for use by or in connection with any computer related system or method.

As will be appreciated by one skilled in the art, aspects of the present invention can be embodied as a system, method or computer program product. Accordingly, aspects of the present invention may take the form of an entirely hardware embodiment (computerized system performing the steps of the present methods), an entirely software embodiment (including firmware, resident software, micro-code, etc.) or an embodiment combining software and hardware aspects. Furthermore, aspects of the present invention may take the form of a computer program product embodied in one or more computer readable medium(s) having computer readable non-transient program code embodied thereon, executed at the client and/or node sides.

Any combination of one or more computer readable medium(s) can be utilized. The computer readable medium can be a computer readable signal medium or a computer readable storage medium. A computer readable storage medium can be, for example, but is not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium can be any tangible medium that can contain, or store a program for use by or in connection with an instruction execution system, apparatus, or device.

A computer readable signal medium may include a propagated data signal with computer readable non-transient program code embodied therein, for example, in baseband or as part of a carrier wave. Such a propagated signal may take any of a variety of forms, including, but not limited to, electro-magnetic, optical, or any suitable combination thereof. A computer readable signal medium can be any computer readable medium that is not a computer readable storage medium and that can communicate, propagate, or transport a program for use by or in connection with an instruction execution system, apparatus, or device.

Non-transient program code embodied on a computer readable medium can be transmitted using any appropriate medium, including but not limited to wireless, wireline, optical fiber cable, RF, etc., or any suitable combination of the foregoing.

Computer non-transient program code for carrying out operations for aspects of the present invention can be written in any combination of one or more programming languages, including an object oriented programming language such as Java, Smalltalk, C++ or the like and conventional procedural programming languages, such as the “C” programming language or similar programming languages. The non-transient program code may execute entirely on the unit 101, partly thereon, partly on a unit 101 and another unit, similar or not. It may execute partly on a first computer and partly on a second computer or entirely on one of the client's computer, etc.

Aspects of the present invention are described above with reference to flowchart illustrations and/or block diagrams of methods (FIGS. 3-4), apparatus (systems, FIGS. 1, 2 and 5) and computer program products according to embodiments of the invention. It will be understood that each block of the flowchart illustrations and/or block diagrams can be implemented by computer program instructions. These computer program instructions can be provided to one or more processors of general purpose computers, special purpose computers, or other programmable data processing apparatuses to produce a computerized system (a machine), such that the instructions, which execute via the processors create means for implementing the functions/acts specified in the flowchart and/or block diagram block or blocks.

The computer program instructions may also be loaded onto one or more computer(s), other programmable data processing apparatus(es), or other devices to cause a series of operational steps to be performed to produce computer implemented processes such that the instructions being executed provide processes for implementing the functions/acts specified in the flowchart and/or block diagram block or blocks.

The flowchart and block diagrams in FIGS. 1-4 illustrate the architecture, functionality, and operation of possible implementations of systems, methods and computer program products according to various embodiments of the present invention. In this regard, each block in the flowchart or block diagrams may represent a module, segment, or portion of code, which includes one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved and considerations of algorithm optimization, parallelization, etc. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the present invention has been described with reference to certain embodiments, it will be understood by those skilled in the art that various changes can be made and equivalents can be substituted without departing from the scope of the present invention. In addition, many modifications can be made to adapt a particular situation to the teachings of the present invention without departing from its scope. Therefore, it is intended that the present invention not be limited to the particular embodiment disclosed, but that the present invention will include all embodiments falling within the scope of the appended claims. For example, many modifications to the interfaces implemented by the nodes can be used for the purpose of allowing clients to execute special functions at the nodes, etc.

1. A method for reading from and writing to a distributed, asynchronous and fault-tolerant storage system comprising storage nodes, said storage nodes communicating with clients, the method comprising:
from a first client writing an object to said storage system:
retrieving from a first set of nodes amongst said storage nodes previous transient metadata relating to a previously written version of said object; and
storing a new version of said object together with new transient metadata identifying said new version on a second set of nodes amongst said storage nodes, wherein said new transient metadata are metadata computed based on said previous transient metadata; and
from a second client reading said object from said storage system:
retrieving a set of transient metadata from a third set of nodes amongst said storage nodes;
determining from said set of transient metadata retrieved a specific version of said object as stored on said storage system; and
retrieving said specific version of said corresponding object from a fourth set of nodes amongst said storage nodes,
wherein two sets of nodes amongst said first, second, third and fourth sets have at least one node in common.

2. The method according to claim 1, further comprising at a third client:
retrieving, from a fifth set of nodes amongst said storage nodes, a set of transient metadata;
determining from said retrieved set of transient metadata a version of an object to be altered, as stored on said storage system; and
instructing said storage system to alter said determined version of said object to be altered,
wherein two sets of nodes amongst said first to fifth sets have at least one node in common, and
wherein said object to be altered is an object to be deleted, and said third client instructs said storage system to delete said determined version of said object to be deleted.

3. The method according to claim 2, wherein:
transient metadata related to a version of a stored object comprise a key uniquely identifying said version, and
storage nodes are equipped with respective key-value storage interfaces,
wherein each of said key-value storage interfaces comprises operations allowing a client communicating with a storage node for:
storing thereon a pair comprising a key and an object; and
retrieving therefrom an object for a given key,
wherein said step of retrieving specific transient metadata comprises instructing one or more nodes of said third set to list keys corresponding to pairs of key and object as stored on said one or more nodes.

4. The method according to claim 3, wherein each of said key-value storage interfaces further comprises an operation allowing a client communicating with a storage node for deleting a pair comprising a key and an object, based on a key provided to said key-value storage interface of that storage node.

5. The method according to claim 4, wherein, at said step of said first client storing said new version, said first client stores at least two copies of said new version of said object, wherein:
a first one of said copies is stored together with said new transient metadata; and
a second one of said two copies is stored together with universal metadata, wherein universal metadata are metadata known by several clients.

6. The method according to claim 5, wherein at said step of retrieving said specific version of said object:
said second client attempts to retrieve said first one of said two copies of said specific version based on the determined specific transient metadata; and
provided that said first one of said two copies cannot be obtained, said second client attempts to retrieve said second one of said two copies, based on universal metadata associated with said specific version of said object.

7. The method according to claim 6, wherein:
at said step of said first client storing said new version, said first client stores said second one of said two copies together with universal metadata and said new transient metadata; and
said step of said second client attempting to retrieve said second one of said two copies further comprises comparing transient metadata stored together with said second one of said two copies with said determined specific transient metadata.

8. The method according to claim 7, wherein said step of comparing is carried out in order to determine whether said second copy has been written no earlier than said first copy determined to correspond to said retrieved specific transient metadata.

9. The method according to claim 8, wherein further comprising:
repeating at a subsequent time, from said second client, the steps of retrieving specific transient metadata, determining a specific version of said object and retrieving said specific version of said object, depending on an outcome of said step of comparing.

10. The method according to claim 1, further comprising:
from said second client, said storage nodes accessing an object from said storage system:
retrieving a set of transient metadata from said third set of nodes;
determining from said set of retrieved transient metadata a specific version of said object as stored on said storage system;
storing on a sixth set of nodes reservation metadata for said specific version of said object as stored and retrieving said specific version as stored from said fourth set of nodes amongst said storage nodes; and
after retrieving said specific version, removing said corresponding reservation metadata from at least some of said nodes in said storage system; and
from a third client, writing or accessing said object concurrently accessed by said second client:
retrieving from said first set of nodes previous transient metadata relating to a previously written version of said object and reservation metadata, if any, associated with a version of said object concurrently accessed,
wherein two sets of nodes amongst said first, second, third, fourth, and sixth sets have at least one node in common.

11. The method according to claim 2, further comprising:
from said second client, said storage nodes accessing an object from said storage system:
retrieving a set of transient metadata from said third set of nodes;
determining from said set of retrieved transient metadata a specific version of said object as stored on said storage system;
storing on a sixth set of nodes reservation metadata for said specific version of said object as stored and retrieving said specific version as stored from said fourth set of nodes amongst said storage nodes; and
after retrieving said specific version, removing said corresponding reservation metadata from at least some of said nodes in said storage system; and
from said third client, writing or accessing said object concurrently accessed by said second client:
retrieving from said first set of nodes previous transient metadata relating to a previously written version of said object and reservation metadata, if any, associated with a version of said object concurrently accessed,
wherein two sets of nodes amongst said first, second, third, fourth, fifth and sixth sets have at least one node in common.

12. The method according to claim 11, further comprising, from said third client:
instructing said storage system to alter said version of said object concurrently accessed, depending on retrieved reservation metadata associated with said version of said object concurrently accessed,
wherein said above step of instructing is a step of instructing said storage system to delete said version of said object.

13. The method according to claim 11, wherein said reservation metadata are metadata computed based on reservation metadata and/or transient metadata previously stored for said object being concurrently accessed.

14. The method according to claim 12, wherein said reservation metadata are metadata computed based on reservation metadata and/or transient metadata previously stored for said object being concurrently accessed.

15-20. (canceled)
